(19) United States
(12) Patent Application Publication
(10) Pub. No.: US 2006/0285357 A1
(43) Pub. Date: Dec. 21, 2006

(54) Neon light structure assembly

(76) Inventor: Shing-Jy Shyu, Taishan Township (TW)

Correspondence Address: TROXELL LAW OFFICE PLLC, SUITE 1404, 5205 LEESBURG PIKE, FALLS CHURCH, VA, 22041, US

(21) Appl. No.: 11/156,640

(22) Filed: Jun. 21, 2005

(51) Int. Cl. F21V 7/04

(52) U.S. Cl. 362/611

(57) ABSTRACT

A neon light structure assembly including a light controller and a pull chain switch disposed within a holding cavity of a disc. The pull chain switch is affixed within the holding cavity of the disc by screws. Moreover a screw penetrates a circular hole center of the holding cavity and extends into the light-focusing shade. A light-reflecting protective cover is attached to a holding cavity of the disc, and light tubes are further disposed within the holding cavity of the disc. The disc and the light-focusing shade are molded as integral bodies using a die casting method, thus, assembly time for an arc casing is shortened and structural materials requirements are reduced. Furthermore, a peripheral edge of the light-focusing shade is furnished with an arc configuration that enables focusing and transmission of light, result in the neon light producing multicolor variation by using light tubes of different colors.

### BACKGROUND OF THE INVENTION

(a) Field of the Invention

The present invention provides an improved neon light structure assembly having structural characteristics in that a light controller and a pull chain switch are disposed within a disc. The neon light is able to produce multicolor variation by using light tubes of different colors.

(b) Description of the Prior Art

Referring to FIGS. 1 and 2, which show the structural assembly of a conventional neon light A having structural characteristics including a vertical shaft A3 and a pull chain switch A4 disposed in a holding cavity A2 of a light-reflecting disc Al. Moreover, an arc cover C is further disposed on the light-reflecting disc A1 and a transparent cover B. The arc cover C provides for covering the vertical shaft A3 and the pull chain switch A4 of the light-reflecting disc A1.

When assembling the neon light A, assembly time is lengthened because the vertical shaft A3 and the pull chain switch A4 are exterior of the transparent cover B. Moreover, because of the additional arc cover C fitted on the transparent cover B, thus, not only is size of the entire neon light A structure increased, but also material requirements are substantially increased.

Hence, the inventor of the present invention proposes to resolve and surmount existent technical difficulties to eliminate the aforementioned shortcomings and provide an improved neon light structure assembly.

### SUMMARY OF THE INVENTION

The present invention is to provide an improved neon light structure assembly having structural characteristics in that a light controller and a pull chain switch are disposed within a disc, moreover, both the disc and a light-focusing shade are molded as integral bodies using a die casting method. A side edge of the light-focusing shade is furnished with an arc configuration that enables focusing and transmission of light. When assembling the arc casing of the neon light structure assembly, because its structure is molded as an integral body using a die casting method, thus, assembly time is shortened and structural material requirements are reduced. Furthermore, when the arc casing is fitted to a ceiling, because the light-focusing shade is furnished with the arc configuration that enables focusing and transmission of light, thus, the neon light is able to produce multicolor variation by using light tubes of different colors.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of a conventional neon light.

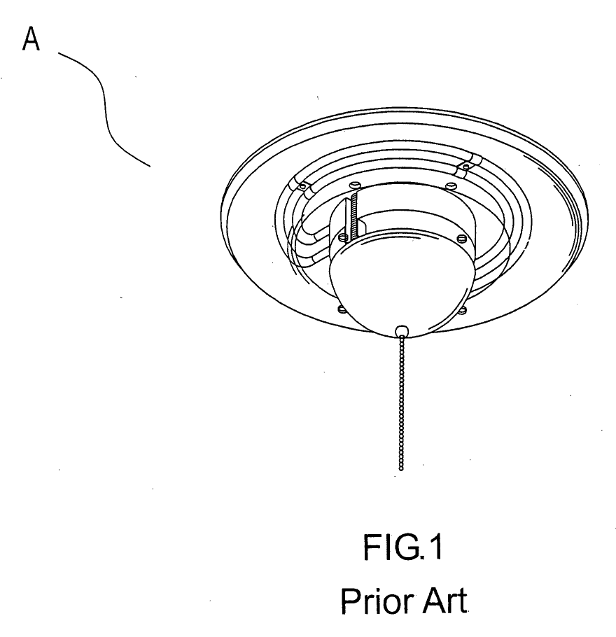

FIG. 2 shows an exploded elevational view of a conventional neon light.

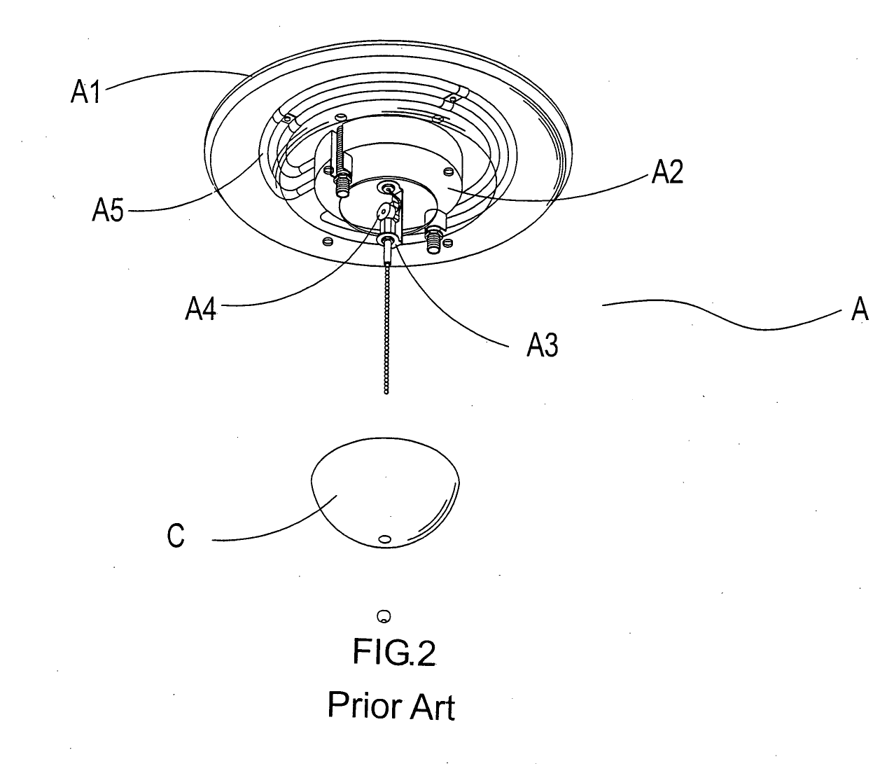

FIG. 3 shows an elevational view according to the present invention.

FIG. 4 shows an exploded elevational view according to the present invention.

FIG. 5 shows an enlarged partial view according to the present invention.

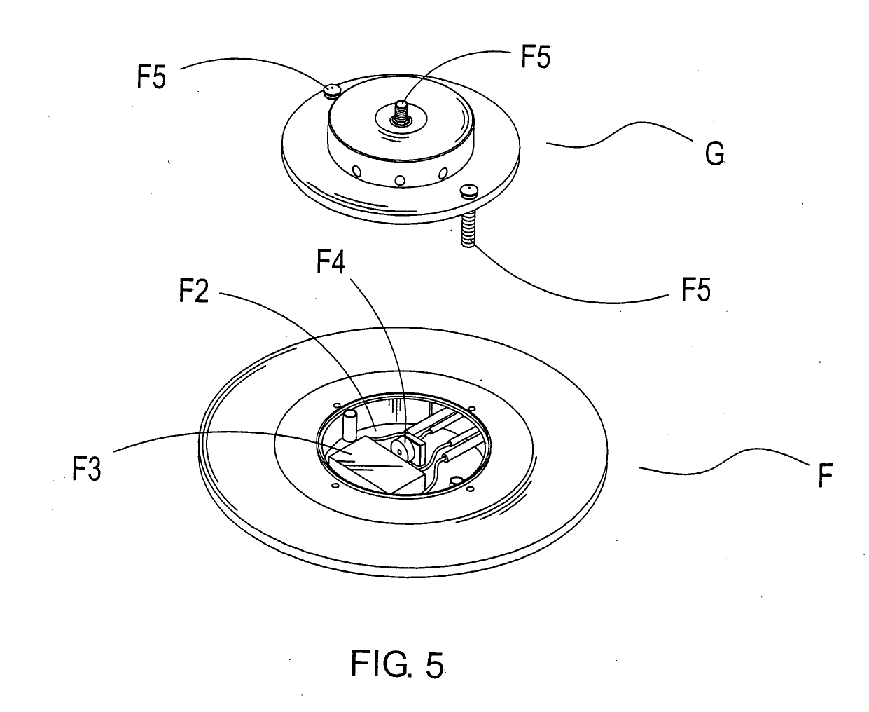

FIG. 6 shows a schematic view of an embodiment according to the present invention.

### DETAILED DESCRIPTION OF THE PREFERRED EMBODIMENTS

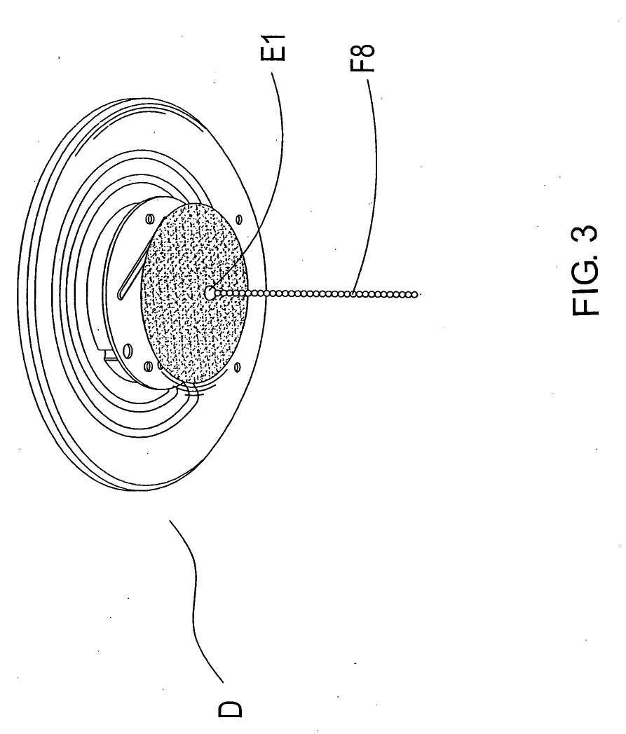

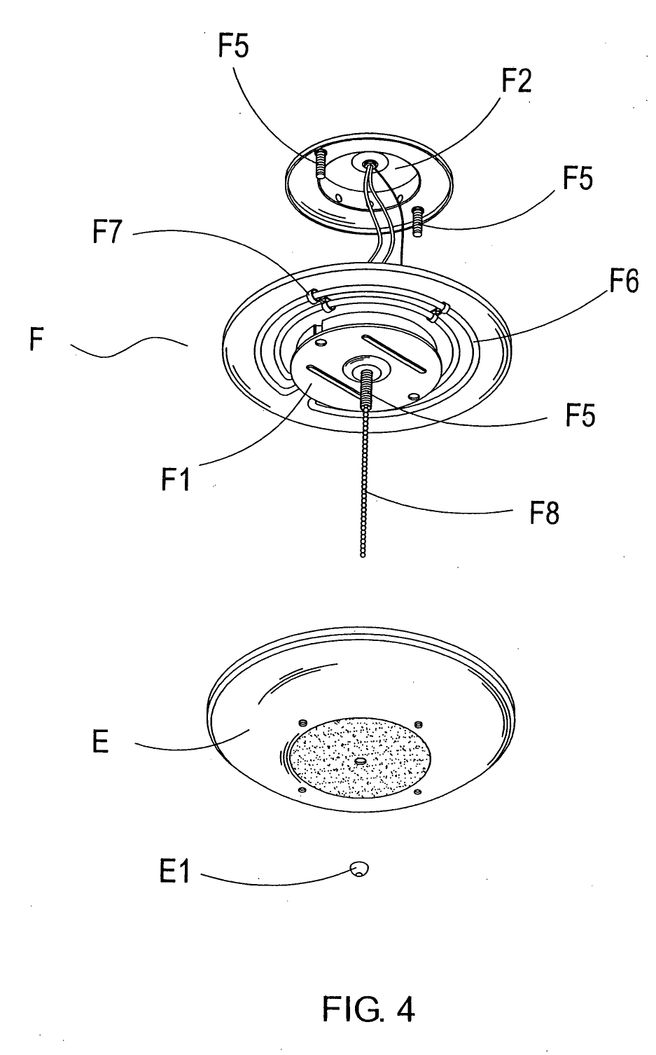

Referring to FIGS. 3 and 4, which show an improved neon light structure assembly of the present invention, wherein a arc casing D is structured to comprise a light-focusing shade E, a disc F, a light-reflecting protective cover F1, a holding cavity F2, a light controller F3, a pull chain switch F4 and a locking disc G.

A peripheral edge of the light-focusing shade E is furnished with an arc configuration that enables focusing and transmission of light. Moreover, a circular hole is defined in a center of the light-focusing shade E corresponding to a screw F5 within the disc F and a pull chain F8 of the pull chain switch F4.

The holding cavity F2 is defined center of the disc F; Within which is disposed the light controller F3 and the pull chain switch F4. Fasteners F7 tightly affix light tubes F6 to the disc F.

The light-reflecting protective cover F1 is attached to the holding cavity F2, to provide for the light tubes F6 of the disc F to reflect colored light. Moreover, circular holes are defined in an outer edge of the light-reflecting protective cover F1 corresponding to screws F5 of the locking disc G.

The holding cavity F2 provides for disposing the light controller F3 and the pull chain switch F4 therein, which actuate a cutover switch action to the light tubes F6 of the disc F.

The screw F5 is configured on the pull chain switch F4, and the pull chain F8 extends down from within the screw F5. The light-focusing shade E is affixed to the disc F by the screw F5 penetrating the circular hole center of the light-focusing shade E and a nut E1 screwing down thereon. Moreover, the pull chain F8 of the pull chain switch F4 actuates the cutover switch action.

The locking disc G is affixed to the disc F and within the holding cavity F2, and provides for the arc casing D to be affixed to a ceiling. When assembling the aforementioned structure, because the disc F and the light-focusing shade E are molded as integral bodies using a die casting method, thus, assembly time is shortened and structural materials requirements are reduced.

When the arc casing D is suspended from a ceiling, because the light-focusing shade E is furnished with the arc configuration that enables focusing and transmission of light, thus, the neon light is able to produce multicolor variation by using light tubes of different colors.

Structural characteristics of the present invention include the light controller F3 and the pull chain switch F4 being disposed within the holding cavity F2, the disc F and the light-focusing shade E being molded as integral bodies using a die casting method, and a peripheral edge of the light-focusing shade E being furnished with an arc configuration that enables focusing and transmission of light.

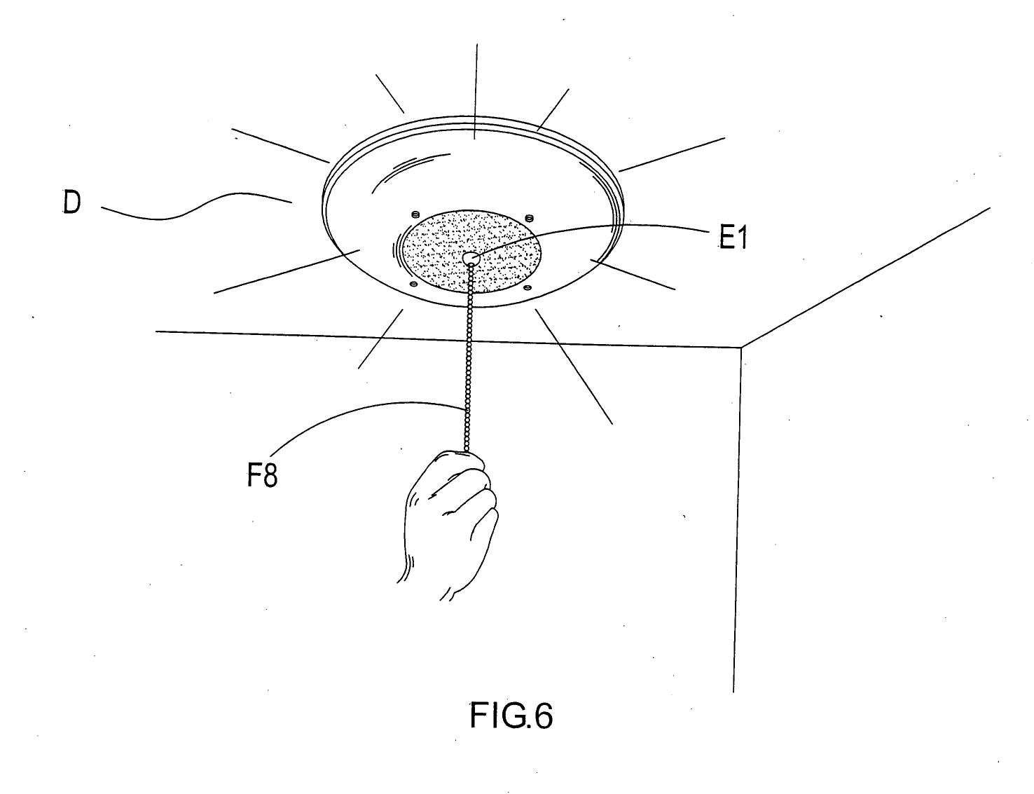

Referring to FIGS. 4 and 6, which show an embodiment of the present invention, wherein an arc casing D is structured to comprise a light-focusing shade E, a light-reflecting protective cover F1, a disc F and a locking disc G. Fasteners F7 are configured on the disc F to enable light tubes F6 to be tightly affixed to the disc F. Moreover, the light-reflecting protective cover F1 is attached to a holding cavity F2 of the disc F. A screw F5 is disposed center of the holding cavity F2, which provides for a pull chain F8 of a pull chain switch F4 to pass there through and extend out from the light-reflecting protective cover F1. Screws F5 are further configured on two sides of the locking disc G, which respectively penetrate holes in the disc F, thereby tightly affixing the disc F to the locking disc G. After securely affixing the disc F to the locking disc G, the pull chain F8 of the pull chain switch F4 threads through the center screw F5.

After the pull chain F8 of the pull chain switch F4 has been threaded through the center screw F5, the pull chain F8 thus extends out from the holding cavity F2 and the light-reflecting protective cover F1. The pull chain F8 and the screw F5 then penetrate a circular hole of the light-focusing shade E, thus, causing the pull chain F8 and the screw F5 to extend out from the light-focusing shade E and enabling a nut E1 to tightly screw down the arc casing D structure.

After fitting the arc casing D to a ceiling, the screw F5 configured center of the locking disc G enables the pull chain F8 of the pull chain switch F4 of the arc casing D to extend downward and suspend in mid air therefrom.

After fitting the arc casing D to a ceiling, because the light-focusing shade E is furnished with an arc configuration that enables focusing and transmission of light, thus, the neon light is able to produce multicolor variation by using light tubes of different colors.

In order to better explicitly disclose advancement and practicability of the present invention, a comparison with conventional art is described hereinafter:

Shortcomings of conventional art:

1. Structure assembly is complicated, which increases assembly time.

2. Poor variability, which increases rate of elimination through competition.

3. Lack of originality and convenience. Advantages of the present invention:

1. Structure devices are minimized, thus lowering manufacturing costs.

2. Simple structure assembly, which decreases assembly time.

3. Capable of varying different focusing structures according to preferences of a user.

4. Provided with practicability and advancement.

5. Provided with originality and convenience.

6. Increases commercial competitiveness.

In conclusion, the present invention in surmounting structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A neon light structure assembly, comprising a light-focusing shade, a light-reflecting protective cover, a disc and a locking disc, and characterized in that the disc and the light-focusing shade are molded as integral bodies using a die casting method;
a peripheral edge of the light-focusing shade is furnished with an arc configuration that enables focusing and transmission of light;
the disc and the locking disc are respectively configured with a holding cavity, a light controller and a pull chain switch, which are connected to light tubes, are disposed within the holding cavity of the disc, and fasteners tightly affix the light tubes to the disc;
the pull chain switch is affixed within the holding cavity of the disc by screws, moreover a screw penetrates a circular hole center of the holding cavity and extends into the light-focusing shade; after the pull chain switch extends out from the holding cavity and the light-reflecting protective cover, a pull chain of the pull chain switch then penetrates the circular hole of the light-focusing shade, at which time the pull chain switch and the screw extend outward from the light-focusing shade, thereby enabling a nut to screw down on the screw and tightly secure an arc casing;
when the light tubes within the arc casing are emitting light, because the light-focusing shade is furnished with the arc configuration that enables focusing and transmission of light, thus, not only are the light rays transmitted through the light-focusing shade, but are also directed out from the peripheral edge of the light-focusing shade, thereby enhancing light illumination effectiveness.
